(19) United States
(12) Patent Application Publication
(10) Pub. No.: US 2015/0151311 A1
(43) Pub. Date: Jun. 4, 2015

(54) SPIN COATING APPARATUS AND SPIN COATING METHOD

(71) Applicant: SAMSUNG ELECTRONICS CO., LTD., Suwon-si (KR)

(72) Inventors: Jang-Kyung JUNG, Osan-si (KR); Young-Soo PARK, Hwaseong-si (KR)

(21) Appl. No.: 14/449,246

(22) Filed: Aug. 1, 2014

(30) Foreign Application Priority Data
Dec. 3, 2013 (KR) 10-2013-0149147

(51) Int. Cl. B05B 3/18; B05B 12/00; B05D 1/02; B05C 5/02; B05D 1/00; B05C 11/08

(52) U.S. Cl. CPC B05B 3/18; B05D 1/005; B05C 11/08; B05D 1/02; B05C 5/02; B05B 12/00

(57) ABSTRACT

A spin coating method includes rotating a wafer, moving a nozzle from a first position at a center region of the wafer to a second position at an edge region of the wafer while discharging a coating material from the nozzle toward the wafer, and stopping the nozzle at the second position and discharging the coating material from the nozzle at the second position.

### CROSS-REFERENCE TO RELATED APPLICATION

Korean Patent Application No. 10-2013-0149147, filed on Dec. 3, 2013, in the Korean Intellectual Property Office, and entitled: “Spin Coating Apparatus And Spin Coating Method,” is incorporated by reference herein in its entirety.

### BACKGROUND

1. Field

Example embodiments relate to a spin coating apparatus and a spin coating method.

2. Description of the Related Art

A SOG (Spin On Glass) process is performed to form a photoresist layer or an insulating layer on a wafer. In particular, the SOG process is often used to get good flatness and good filling ability which are not achieved by a vapor deposition process.

### SUMMARY

According to example embodiments, there is provided a spin coating method. A wafer is rotated. A nozzle moves from a first position at a center region of the wafer to a second position at an edge region of the wafer. The nozzle discharges a coating material through the nozzle. The nozzle is stopped on the second position and the nozzle discharges the coating material through the nozzle.

In example embodiments, the nozzle may further move from the second position to a third position at the center region of the wafer and discharge the coating material.

In example embodiments, when the nozzle moves from the first position to the second position, the nozzle may move in a first direction parallel to an upper surface of the wafer or in a second direction perpendicular to the first direction.

In example embodiments, stopping the nozzle on the second position and discharging the coating material may be performed during a time which is within a range of 0.5 sec to 2 sec.

In example embodiments, when the nozzle moves and discharges the coating material, the nozzle may move at a speed which is within a range of 100 mm/sec to 200 mm/sec.

In example embodiments, a discharging rate of the coating material may be within a range of 0.4 cc/sec to 1.0 cc/sec.

In example embodiments, molecular weight of the coating material may be within a range of 3000 to 20000.

In example embodiments, when the wafer is rotated, the wafer may be rotated at a rotational speed which is within a range of 500 rpm to 1500 rpm.

According to other example embodiments, there is provided a spin coating apparatus. The spin coating apparatus includes a wafer support part supporting a wafer, the wafer support part including a rotation driving part rotating the wafer, a discharge part above the wafer support part and including a movable nozzle, the nozzle discharging a coating material onto the wafer, a nozzle driving part connected to the discharge part and moving the nozzle above the wafer, and a control part connected to the wafer support part, the discharge part, and the nozzle driving part, the control part controlling operation of the nozzle, wherein the nozzle is movable from a first position at a center region of the wafer to a second position at an edge region of the wafer during discharge of the coating material at a first discharge rate, and the nozzle is stationary at the second position to discharge the coating material at a second discharge rate.

In example embodiments, the nozzle driving part may move the nozzle in a first direction parallel to an upper surface of the wafer or in a second direction perpendicular to the upper surface of the wafer.

In example embodiments, the nozzle may be movable and the rotation driving part may be rotatable during discharge at the first discharge rate, and the nozzle may be stationary and the rotation driving part may be rotatable during discharge at the second discharge rate.

In example embodiments, the nozzle may be movable from the second position to a third position at the center region of the wafer to discharge the coating material at the third position at a third discharge rate.

In example embodiments, the discharge part may include at least a first discharge part and a second discharge part.

In example embodiments, the first and second discharge part may discharge different coating materials, respectively.

In example embodiments, the nozzle driving part may include at least a first a nozzle driving part and a second nozzle driving part corresponding to the first and second discharge parts.

According to other example embodiments, there is provided a spin coating method. The method includes continuously rotating a wafer, moving a nozzle from a first position at a center region of the wafer to a second position at an edge region of the wafer while discharging a coating material from the nozzle toward the wafer, during rotation of the wafer, and stopping the nozzle at the second position and discharging the coating material from the nozzle at the second position, during rotation of the wafer.

In example embodiments, moving the nozzle from the first position to the second position may include continuously discharging the coating material toward the wafer, while rotating the wafer and moving the nozzle.

In example embodiments, stopping the nozzle at the second position may include maintaining the nozzle stationary, while continuously discharging the coating material at the second and rotating the wafer.

In example embodiments, moving the nozzle from the first position to the second position may include discharging the coating material at a first discharge rate, and stopping the nozzle at the second position may include discharging the coating material at a second discharge rate different from the first discharge rate.

In example embodiments, moving the nozzle from the first position to the second position includes moving the nozzle in parallel to an upper surface of the wafer.

### BRIEF DESCRIPTION OF THE DRAWINGS

Example embodiments will be more clearly understood from the following detailed description taken in conjunction with the accompanying drawings. FIGS. 1 to 7 represent non-limiting, example embodiments as described herein.

FIG. 1 illustrates a schematic cross-sectional view of a spin coating apparatus in accordance with example embodiments.

FIG. 2 illustrates a schematic perspective view of the spin coating apparatus in FIG. 1.

FIG. 3A illustrates a plan view of a portion of the spin coating apparatus of FIG. 1 with a nozzle at a first position.

FIG. 3B illustrates a schematic cross-sectional view of a stage in an operation of the spin coating apparatus of FIG. 1, with the nozzle moving from the first position to a second position during discharge of a coating material.

FIG. 3C illustrates a schematic cross-sectional view of a stage in an operation of the spin coating apparatus of FIG. 1, with the nozzle discharging the coating material at the second position.

FIG. 4 illustrates a schematic cross-sectional view of a spin coating apparatus in accordance with other example embodiments.

FIG. 5A illustrates a plan view of a portion of the spin coating apparatus of FIG. 4, with a first nozzle at a first position and a second nozzle at a second position.

FIG. 5B illustrates a schematic cross-sectional view of a stage in an operation of the spin coating apparatus of FIG. 4, with the first nozzle moving from the first position to a second position and the second nozzle moving from the second position to the first position during discharge of a coating material.

FIG. 5C illustrates a schematic cross-sectional view of a stage in an operation of the spin coating apparatus of FIG. 4, with the first nozzle discharging the coating material at the second position and the second nozzle discharging the coating material at the first position.

FIG. 6 illustrates a flowchart of a spin coating method in accordance with example embodiments.

FIG. 7 illustrates a flowchart of a spin coating method in accordance with other example embodiments.

### DETAILED DESCRIPTION

Various example embodiments will be described more fully hereinafter with reference to the accompanying drawings, in which some example embodiments are shown. Example embodiments may, however, be embodied in many different forms and should not be construed as limited to those set forth herein. Rather, these example embodiments are provided so that this description will be thorough and complete, and will fully convey exemplary implementations to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, a region illustrated as a rectangle may have rounded or curved features at its edges. Thus, the regions illustrated in the figures are schematic in nature and their shapes are not intended to limit example embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

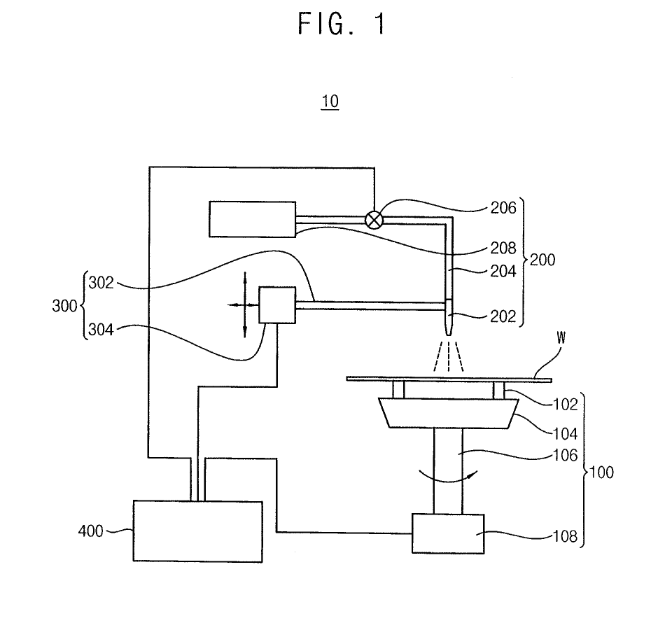

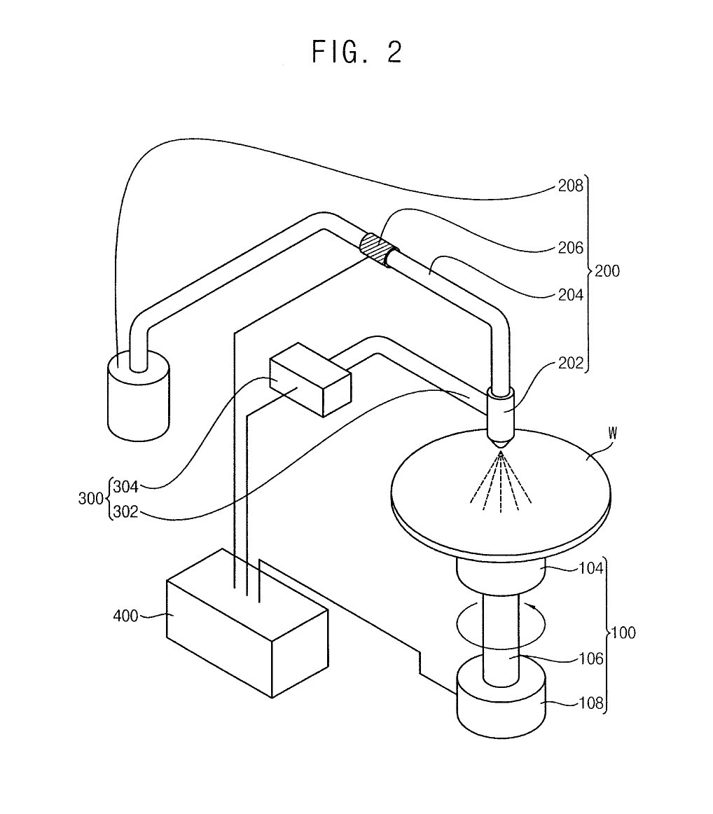

FIG. 1 illustrates a cross-sectional view of a spin coating apparatus in accordance with example embodiments. FIG. 2 illustrates a perspective view of the spin coating apparatus in FIG. 1.

Referring to FIGS. 1 and 2, a spin coating apparatus 10 may include a wafer support part 100 to support and rotate a wafer W, a discharge part 200 on, e.g., above, the wafer support part 100 to discharge a coating material on the wafer W, a nozzle driving part 300 connected to the discharge part 200 to move a nozzle 202 of the discharge part 200 above the wafer W, and a control part 400 connected to the wafer support part 100, the discharge part 200, and the nozzle driving part 300 to control their operation.

In example embodiments, the wafer support part 100 may include a wafer holding part 102, a stage 104, a rotation shaft 106, and a rotation driving part 108.

The stage 104 may provide a space to process the wafer W, and the wafer holding part 102 may be disposed on the stage 104 to hold the wafer W. For example, the wafer W may include a silicon wafer. The wafer holding part 102 may hold the wafer W on the stage 104 by a mechanical or a hydraulic holding member.

The rotation shaft 106 may be connected to the stage 104, and the rotation driving part 108 may transmit a rotational force to the stage 104 through the rotation shaft 106. For example, the rotation driving part 108 may include a DC motor or an AC motor. As illustrated later, in example embodiments, the rotation driving part 108 may be controlled by the control part 400 to adjust a rotational speed of the rotation shaft 106 and the wafer W.

In example embodiments, the discharge part 200 may include the nozzle 202, a discharge arm 204, a discharge control valve 206, and a coating material supply 208.

The nozzle 202 may be arranged on, e.g., above, the wafer support part 100 and discharge the coating material on, e.g., onto, the wafer W. For example, the nozzle 202 may be a spray-type nozzle. The nozzle 202 may have at least one nozzle hole.

The nozzle 202 may be connected to the coating material supply 208 through the discharge arm 204. The coating material may be transferred from the coating material supply 208 to the nozzle 202 through the discharge arm 204. A supply pipe may be provided in the discharge arm 204 for a flow of the coating material. The discharge control valve 206 may be provided on the discharge arm 204. As illustrated later, the discharge control valve 206 may be controlled by the control part 400 to adjust a flow rate of the coating material and a discharge rate of the nozzle 202.

The nozzle driving part 300 may be connected to the discharge part 200 and move the nozzle 202 on, e.g., above, the wafer W. In example embodiments, the nozzle driving part 300 may include a driving arm 302 and a driving motor 304.

In example embodiments, the driving motor 304 may be connected to the nozzle 202 through the driving arm 302. The driving motor 304 may move the nozzle 202 from a first position, e.g., at a center region of the wafer W, to a second position, e.g., at an edge region of the wafer W.

The driving motor 304 may move the nozzle 202 in a first direction, e.g., a horizontal direction, and/or a second direction, e.g., a vertical direction, through the driving arm 302. The horizontal direction is substantially parallel to an upper surface of the wafer W, e.g., along a radius of the wafer W, and the vertical direction is substantially perpendicular, e.g., normal, to the upper surface of the wafer W.

As illustrated later, the driving motor 304 may be controlled by the control part 400 to adjust the operation thereof. A moving direction and a moving speed of the nozzle 202 may be controlled by the control part 400.

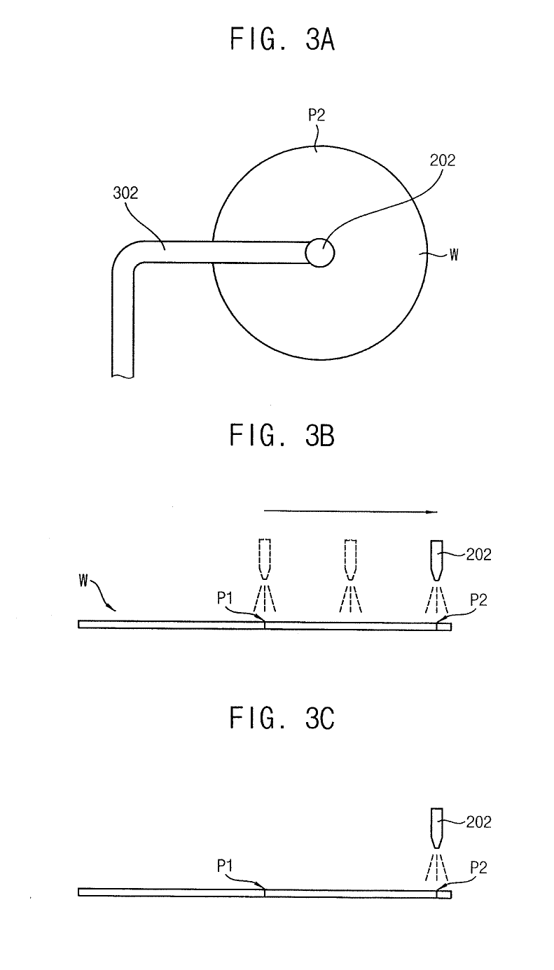

In example embodiments, the control part 400 may be connected to the wafer support part 100, the discharge part 200, and the nozzle driving part 300 to control the operation of the nozzle 202. The control part 400 may control the nozzle 202 to move from the first position, i.e., at the center region of the wafer W, to the second position, i.e., at the edge region of the wafer W, to discharge the coating material at a first discharge rate. Further, the control part 400 may control the nozzle 202 to stop at the second position to discharge the coating material at a second discharge rate. The operation of the nozzle 202 controlled by the control part 400 will be explained in detail below with reference to FIGS. 3A to 3C.

In example embodiments, a molecular weight of the coating material may be within a range of about 3000 to about 20000. The molecular weight affects mobility, e.g., fluidity, of the coating material between the nozzle 202 and the wafer W. As such, the indicated range of the molecular weight provides appropriate fluidity to impart uniformity of the coating material on the wafer W.

Hereinafter, the operation of the spin coating apparatus 10 will be explained with reference to FIGS. 3A-3C. FIGS. 3A-3C illustrate views of stages in the operation of the spin coating apparatus 10.

FIG. 3A illustrates a plan view of a portion of the spin coating apparatus 10 with the nozzle 202 at the first position. FIG. 3B illustrates a cross-sectional view of the spin coating 10 with the nozzle 202 moving from the first position to the second position while discharging the coating material. FIG. 3C illustrates a cross-sectional view of the spin coating apparatus 10 with the nozzle 202 discharging the coating material at the second position.

Referring to FIG. 3A, the nozzle 202 may be at the first position P1 at, e.g., above, the center region of the wafer W before the coating material is discharged.

Referring to FIG. 3B, the nozzle 202 may move from the first position P1 at the center region of the wafer W to the second position P2 at the edge region of the wafer W during a first period T1. Simultaneously, i.e., during the first period T1, the nozzle 202 may discharge the coating material onto the wafer W. That is, the nozzle 202 discharges, e.g., continuously, the coating material toward the wafer W during its movement from the first position P1 to the second position P2, e.g., the nozzle 202 is movable during the discharge in the first period T1.

For example, the moving speed of the nozzle 202 may be about 100 mm/sec to about 200 mm/sec. A first discharge rate of the coating material from the nozzle 202, i.e., a discharge rate during the first period T1, may be about 0.4 cc/sec to about 1.0 cc/sec.

Referring to FIG. 3C, the nozzle 202 may be stopped at the second position P2 at the edge region of the wafer W during a second period T2, so that the coating material is discharged at the second position P2 during the second period T2. That is, the nozzle 202 remains stationary at the second position P2 during the second period T2 to discharge the coating material, e.g., only, at the second position P2, e.g., to discharge sufficient coating material at the edge region to provide uniform thickness on the entire wafer W.

For example, the second period T2 may be about 0.5 sec to about 2.0 sec. A second discharge rate of the coating material, i.e., a discharge rate during the second period T2, may be about 0.4 cc/sec to about 1.0 cc/sec.

The control part 400 may control the nozzle 202 to move from the second position P2 to a third position, e.g., at the center region of the wafer W, to discharge the coating material at a third discharge rate. Accordingly, discharge of coating material both at the center and edge regions of the wafer W may be controlled to provide uniform thickness of the coating material on the wafer W.

According to the spin coating apparatus 10, the wafer W may be coated by the coating material, which is discharged from the nozzle 202 uniformly, so that it may improve filling ability in critical dimension. Movement of the nozzle 202, the discharge rate of the coating material, and the rotational speed of the wafer W may be optimized so that consumption of the coating material is reduced and the coating material on the wafer W exhibits a good filling ability and a surface uniformity.

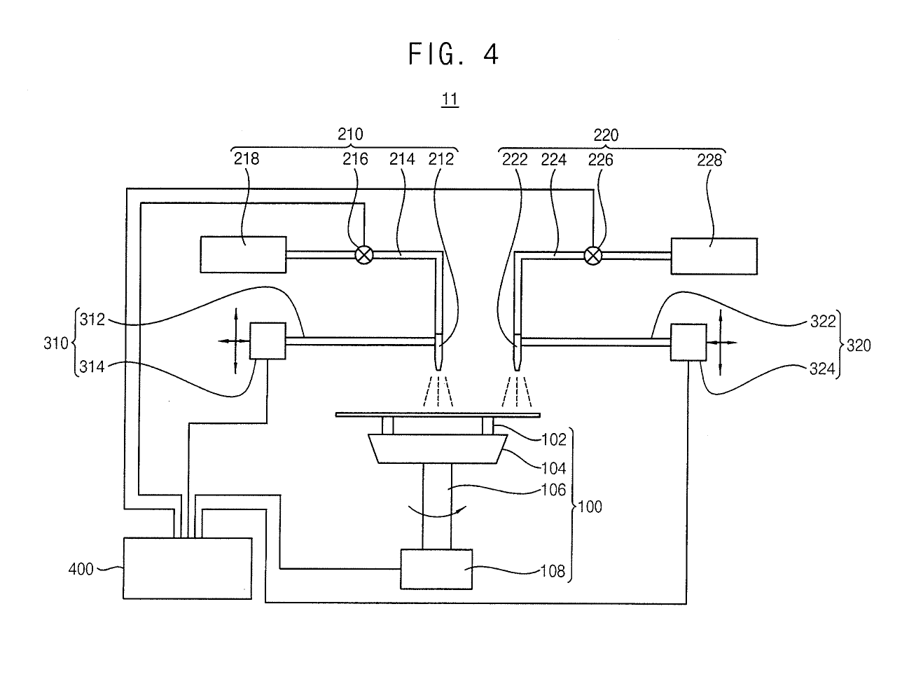

FIG. 4 illustrates a cross-sectional view of a spin coating apparatus in accordance with example embodiments. The spin coating apparatus may be substantially the same as or similar to that of FIG. 1, except for a discharge part and a nozzle driving part. Thus, like reference numerals refer to like elements, and repetitive explanations may be omitted herein. The discharge part and the nozzle driving part will mainly be explained.

Referring to FIG. 4, a spin coating apparatus 11 may include a the support part 100, first and second discharge parts 210 and 220, first and second nozzle driving parts 310 and 320, and the control part 400.

In example embodiments, the wafer support part 100 may include the wafer holding part 102, the stage 104, the rotation shaft 106, and the rotation driving part 108 to rotate the wafer W. The stage 104 may provide a space to process the wafer W, and the wafer holding part 102 may be disposed on the stage 104 to hold the wafer W. The rotation shaft 106 may be connected to the stage 104, and the rotation driving part 108 may transmit rotational force to the stage 104 through the rotation shaft 106.

In example embodiments, the first discharge part 210 may include a first nozzle 212, a first discharge arm 214, a first discharge control valve 216, and a first coating material supply 218.

The first nozzle 212 may be arranged on, e.g., above, the wafer support part 100 and discharge the coating material onto the wafer W. For example, the first nozzle 212 may be a spray-type nozzle. The first nozzle 212 may have at least one nozzle hole.

The first nozzle 212 may be connected to the first coating material supply 218 through the first discharge arm 214. The coating material may be transferred from the first coating material supply 218 to the first nozzle 212 through the first discharge arm 214. The first discharge control valve 216 may be provided on the first discharge arm 214.

In example embodiments, the second discharge part 220 may include a second nozzle 222, a second discharge arm 224, a second discharge control valve 226, and a second coating material supply 228.

The second nozzle 222 may be arranged on, e.g., above, the wafer support part 100 and discharge the coating material onto the wafer W. For example, the second nozzle 222 may be a spray-type nozzle. The second nozzle 222 may have at least one nozzle hole.

The second nozzle 222 may be connected to the second coating material supply 228 through the second discharge arm 224. The second discharge control valve 226 may be provided on the second discharge arm 224.

As illustrated later, the first and second discharge control valves 216 and 226 may be controlled by the control part 400 to adjust flow rates of the coating material and discharge rates of the first and second nozzles 212 and 222. In example embodiments, the first and second coating material supplies 218 and 228 may supply different coating materials.

The first and second nozzle driving parts 310 and 320 may be connected to the first and second discharge parts 210 and 220, respectively, and may move the first and second nozzles 212 and 222 on, e.g., above, the wafer W, respectively.

In example embodiments, the first nozzle driving part 310 may include a first driving arm 312 and a first driving motor 314. The second nozzle driving part 320 may include a second driving arm 322 and a second driving motor 324.

For example, the first driving motor 314 may be connected to the first nozzle 212 through the first driving arm 312. The first driving motor 314 may move the first nozzle 212 in a horizontal or vertical direction through the first driving arm 312. As illustrated later, the first driving motor 312 may be controlled by the control part 400 to adjust operation thereof.

The second driving motor 324 may be connected to the second nozzle 222 through the second driving arm 322. The second driving motor 324 may move the second nozzle 222 in a horizontal or vertical direction through the second driving arm 322. As illustrated later, the second driving motor 322 may be controlled by the control part 400 to adjust operation thereof.

In example embodiments, the control part 400 may be connected to the wafer support part 100, the first and second discharge parts 210 and 220, and the first and second nozzle driving parts 310 and 320 to control the operations of the first and second nozzles 212 and 222.

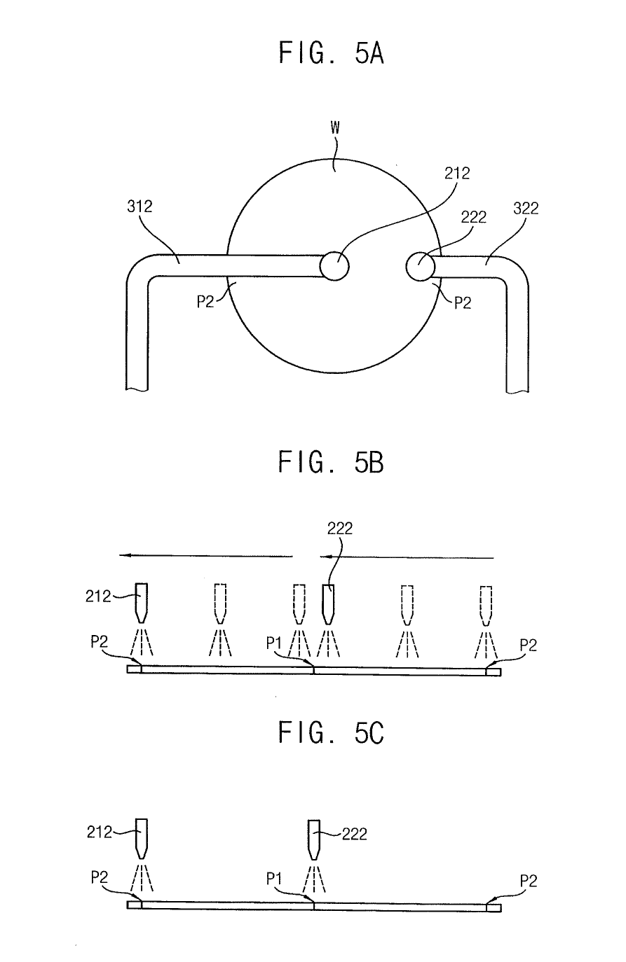

Hereinafter, the operation of the spin coating apparatus 11 in FIG. 4 will be explained in detail with reference to FIGS. 5A-5C.

FIG. 5A illustrates a plan view of the first nozzle 212 and the second nozzle 222 of the spin coating apparatus 11. FIG. 5B illustrates a cross-sectional view of the first and second nozzles 212 and 22 of the spin coating apparatus 11 during movement thereof. FIG. 5C illustrates a cross-sectional view of the first and second nozzles 212 and 222 of the spin coating apparatus 11 when they are stopped.

Referring to FIG. 5A, the first and second nozzles 212 and 222 may be at the first positioned P1 and the second position P2, respectively. For example, before the coating material is discharged, the first and second nozzles 212 and 222 may be at the first and second positions P1 and P2, i.e., above the center and edge regions of the wafer W, respectively.

Referring to FIG. 5B, the first nozzle 212 may move from the first position P1 to the second position P2, and the second nozzle 222 may move from the second position P2 to the first position P1 during the first period T1. Simultaneously, i.e., during the first period T1, the first and second nozzles 212 and 222 may discharge the coating material toward the wafer W.

For example, the first nozzle 212 discharges, e.g., continuously, the coating material toward the wafer W during its movement from the first position P1 toward the second position P2, e.g., while moving left above the wafer W from the center toward an edge (FIGS. 5A-5B). Simultaneously, the second nozzle 222 discharges, e.g., continuously, the coating material toward the wafer W during its movement from the second position P2 toward the first position P1, e.g., while moving left above the wafer W from the edge toward the center (FIGS. 5A-5B).

Referring to FIG. 5C, the first nozzle 212 may be stopped at the second position P2, and the second nozzle 222 may be stopped at the first position P1 during the second period T2 so that the coating material is discharged.

According to the spin coating apparatus 11, it may improve coating uniformity and filling ability of the wafer W. When the wafer W is coated by the first and second nozzles 212 and 222, it may reduce coating time and improve productivity of a semiconductor device.

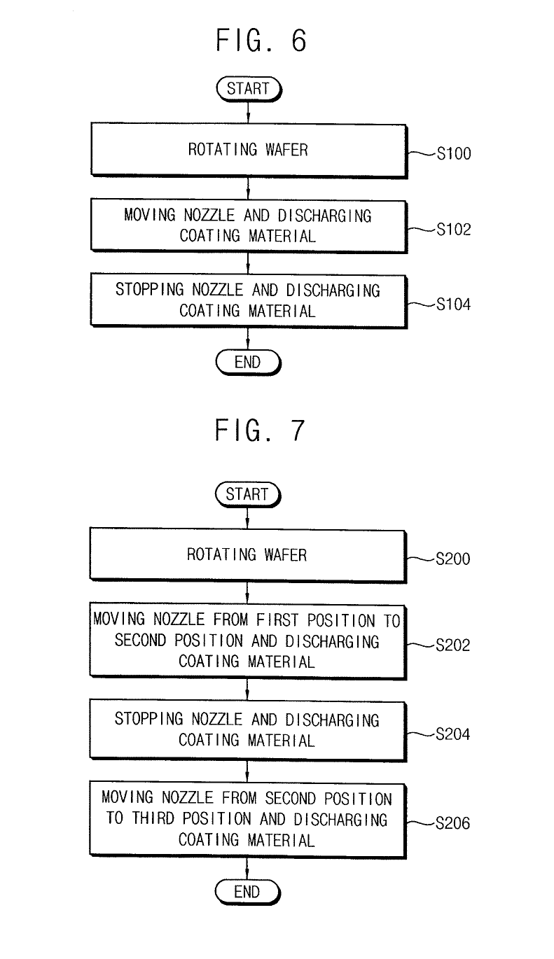

Hereinafter, a spin coating method using the spin coating apparatus in FIG.1 will be explained with reference to FIG. 6. FIG. 6 illustrates a flowchart of a spin coating method in accordance with example embodiments.

Referring to FIGS. 1 and 6, in a spin coating method in accordance with example embodiments, a wafer W may be rotated (S100) e.g., the wafer W may start a continuous rotation by the rotation driving part 108. A rotational force generated by the rotation driving part 108 may be transmitted to the wafer W through the rotation shaft 106 and the stage 104. The wafer holding part 102 may hold the wafer W on the stage 104 not to leave the stage 104. In example embodiments, the rotation driving part 108 may rotate the wafer W at about 500 rpm to about 1500 rpm.

Next, the nozzle 202 may move from the first position at the center region of the wafer W to the second position at the edge region of the wafer W, so that the coating material is discharged onto the wafer W (S102). In example embodiments, the molecular weight of the coating material may be about 3000 to about 20000.

The nozzle driving part 300 may move the nozzle 202 from the first position to the second position. The discharge part 200 may, e.g., continuously, discharge the coating material onto the wafer W, while the wafer W rotates and the nozzle 202 moves from the first position to the second position.

The driving motor 304 included in the nozzle driving part 300 may move the nozzle 202 via the driving arm 302. In example embodiments, the driving motor 304 may move the nozzle 202 at about 100 mm/sec to about 200 mm/sec. The first direction is substantially parallel to the upper surface of the wafer W, and the second direction is substantially perpendicular to the upper surface of the wafer W. The driving motor 304 may move the nozzle in the first direction or the second direction. In example embodiments, the discharge rate of the coating material in operation S102, e.g., the first period T1 described previously with reference to FIG. 3B, may be about 0.4 cc/sec to about 1.0 cc/sec.

Next, the nozzle 202 may be stopped at the second position, so that the coating material is discharged (S 104), e.g., at the second position during the second period T2 described previously with reference to FIG. 3C. For example, while the wafer W starts rotating in operation S100, the wafer W continuously rotates during discharge of the coating material from the nozzle 202, i.e., during operations S100, S102, and S104.

In example embodiments, the discharge time from the instant the nozzle 202 is stopped at the second position until it finished discharging the coating material at the second position may be about 0.5 sec to about 2 sec. The discharge rate of the coating material may be about 0.4 cc/sec to about 1.0 cc/sec.

According to the spin coating method, the coating thickness at the edge region of the wafer W may be controlled. It may improve coating uniformity of the wafer W so that wafer W has an even thickness across the entire region of the wafer W. Further, by optimizing the spin coating method, consumption of the coating material and the coating time may be reduced, thereby increasing productivity of a semiconductor device.

FIG. 7 illustrates a flowchart of a spin coating method in accordance with other example embodiments.

Referring to FIGS. 1 and 7, the wafer W may be rotated (S200). Next, the nozzle 202 may move from the first position at the center region of the wafer W to the second position at the edge region of the wafer W, so that the coating material is discharged on the wafer W (S202).

Next, the nozzle 202 may be stopped at the second position so that the coating material is discharged (S204). Next, the nozzle 202 may move from the second position to a third position at the center region of the wafer W, so that the coating material is discharged (S206).

Movement of the nozzle 202 may be controlled by the control part 400. In particular, the control part 400 may control the driving motor 304 included in the nozzle driving part 300 so that the movement of the nozzle 202 is controlled.

According to the spin coating method in the example embodiments, the wafer W may be coated by the coating material discharged from the nozzle 202 uniformly. Therefore, a filling ability between critical dimensions may be improved. Further, by the optimizing the spin coating method, consumption of the coating material and coating time may be reduced, so that productivity of a semiconductor device increases.

By way of summary and review, a conventional nozzle-fixed SOG apparatus includes a stationary nozzle above a center region of an upper surface of a wafer to discharge a coating material thereon. The wafer is rotated so that the discharged coating material is distributed by centrifugal force from the center region of the upper surface of the wafer to an edge region thereof. However, when the coating material is distributed, e.g., only, by centrifugal force from the center region of the wafer, there may be a thickness difference between the center and edge regions of the coating on the wafer.

In contrast, example embodiments provide a spin coating method for coating a wafer uniformly, and a spin coating apparatus providing the same. That is, according to example embodiments, the wafer may be coated by a coating material discharged from a mobile nozzle, thereby distributing the coating on the upper surface of the wafer both by centrifugal force and by moving the nozzle. As such, the coated material has substantially uniform thickness that improves the filling ability in critical dimension. Further, the movement of the nozzle, the discharge rate of the coating material, and the rotational speed of the wafer W may be optimized, so that consumption of the coating material and coating time is reduced, thereby improving processing conditions and productivity of the wafer W, as well as enhancing filling capacity and surface uniformity of the coating material.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A spin coating method, the method comprising:
rotating a wafer;
moving a nozzle from a first position at a center region of the wafer to a second position at an edge region of the wafer while discharging a coating material from the nozzle toward the wafer; and
stopping the nozzle at the second position and discharging the coating material from the nozzle at the second position.

2. The spin coating method as claimed in claim 1, further comprising moving the nozzle from the second position to a third position at the center region of the wafer and discharging the coating material at the third position.

3. The spin coating method as claimed in claim 1, wherein moving the nozzle from the first position to the second position includes moving the nozzle in a first direction parallel to an upper surface of the wafer or in a second direction perpendicular to the first direction.

4. The spin coating method as claimed in claim 1, wherein stopping the nozzle at the second position and discharging the coating material are performed during a time period of about 0.5 sec to about 2.0 sec.

5. The spin coating method as claimed in claim 1, wherein moving the nozzle and discharging the coating material include moving the nozzle at a speed of about 100 mm/sec to about 200 mm/sec.

6. The spin coating method as claimed in claim 1, wherein discharging the coating material is performed at a rate of about 0.4 cc/sec to about 1.0 cc/sec.

7. The spin coating method as claimed in claim 1, wherein discharging the coating material includes using a coating material having a molecular weight of about 3000 to about 20000.

8. The spin coating method as claimed in claim 1, wherein rotating the wafer includes rotating the wafer at a rotational speed of about 500 rpm to about 1500 rpm.

9. A spin coating apparatus, comprising:
a wafer support part supporting a wafer, the wafer support part including a rotation driving part rotating the wafer;
a discharge part above the wafer support part and including a movable nozzle, the nozzle discharging a coating material onto the wafer;
a nozzle driving part connected to the discharge part and moving the nozzle above the wafer; and
a control part connected to the wafer support part, the discharge part, and the nozzle driving part, the control part controlling operation of the nozzle,
wherein the nozzle is movable from a first position at a center region of the wafer to a second position at an edge region of the wafer during discharge of the coating material at a first discharge rate, and the nozzle is stationary at the second position to discharge the coating material at a second discharge rate.

10. The spin coating apparatus as claimed in claim 9, wherein the nozzle driving part moves the nozzle in a first direction parallel to an upper surface of the wafer or in a second direction perpendicular to the upper surface of the wafer.

11. The spin coating apparatus as claimed in claim 9, wherein the nozzle is movable and the rotation driving part is rotatable during discharge at the first discharge rate, and the nozzle is stationary and the rotation driving part is rotatable during discharge at the second discharge rate.

12. The spin coating apparatus as claimed in claim 9, wherein the nozzle is movable from the second position to a third position at the center region of the wafer to discharge the coating material at the third position at a third discharge rate.

13. The spin coating apparatus as claimed in claim 9, wherein the discharge part includes at least a first discharge part and a second discharge part.

14. The spin coating apparatus as claimed in claim 13, wherein the first and second discharge part discharge different coating materials, respectively.

15. The spin coating apparatus as claimed in claim 13, wherein the nozzle driving part includes at least a first a nozzle driving part and a second nozzle driving part corresponding to the first and second discharge parts.

16. A spin coating method, the method comprising:
continuously rotating a wafer;
moving a nozzle from a first position at a center region of the wafer to a second position at an edge region of the wafer while discharging a coating material from the nozzle toward the wafer, during rotation of the wafer; and
stopping the nozzle at the second position and discharging the coating material from the nozzle at the second position, during rotation of the wafer.

17. The spin coating method as claimed in claim 16, wherein moving the nozzle from the first position to the second position includes continuously discharging the coating material toward the wafer, while rotating the wafer and moving the nozzle.

18. The spin coating method as claimed in claim 17, wherein stopping the nozzle at the second position includes maintaining the nozzle stationary, while continuously discharging the coating material at the second and rotating the wafer.

19. The spin coating method as claimed in claim 18, wherein moving the nozzle from the first position to the second position includes discharging the coating material at a first discharge rate, and stopping the nozzle at the second position includes discharging the coating material at a second discharge rate different from the first discharge rate.

20. The spin coating method as claimed in claim 16, wherein moving the nozzle from the first position to the second position includes moving the nozzle in parallel to an upper surface of the wafer.
